(19) United States
(12) Patent Application Publication
(10) Pub. No.: US 2004/0267591 A1
(43) Pub. Date: Dec. 30, 2004

(54) System and method for dynamic scheduling of personnel

(75) Inventors: Henrik E. Hedlund, Costa Mesa, CA (US); Ali S. Kiran, San Diego, CA (US); Jeffrey Cameron, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: Exametric, Inc.

(21) Appl. No.: 10/633,357

(22) Filed: Aug. 1, 2003

Related U.S. Application Data
(63) Continuation-in-part of application No. 10/610,780, filed on Jun. 30, 2003.

(51) Int. Cl. G06F 17/60

(52) U.S. Cl. 705/9

(57) ABSTRACT

A method and system for creating an optimized workforce schedule for a set of local or remote human resources to insure optimum staff schedules based on forecasted demand, past schedules, employee skill sets, and employee preferences is provided. Upon receiving a request to create a schedule, the system uses a pattern recognition procedure to create the initial workforce schedule. The pattern recognition procedure considers staff attributes and skills as well as past schedules to create the initial workforce schedule. The initial workforce schedule is then refined via a neighborhood search algorithm that incorporates user input and employee preferences to generate an optimized schedule that meets the forecasted demand for selected positions while satisfying employee preferences.

### RELATED APPLICATION

The present application is a continuation-in-part of co-pending U.S. patent application Ser. No. 10/610,780 entitled METHOD AND SYSTEM FOR SCHEDULING AND SHARING A POOL OF RESOURCES ACROSS MULTIPLE DISTRIBUTED FORECASTED WORKLOADS, filed on Jun. 30, 2003, which is incorporated herein by reference in its entirety.

### BACKGROUND

1. Field of the Invention

The present invention generally relates to the scheduling of personnel and more particularly relates to a system and method for automatically scheduling personnel based on individual employee characteristics, forecasted workloads, and past scheduling patterns.

2. Related Art

Conventional workforce scheduling addresses the problem of assigning employees to each of the planning time periods for an organization. Most organizations consider workforce scheduling to have a single objective, which is to create a schedule that meets the forecasted demand as closely as possible, or alternatively meets a specific budget. There are several conventional approaches developed for workforce scheduling. One of the most commonly used approaches is the set covering problem developed by Dantzig. In general, this type of problem can be formulated as a mathematical model as:

$$Min . {\sum }_{j}^{} {c}_{j} {x}_{j}$$

$$s . t . {\sum }_{i}^{} {a}_{ij} {x}_{j} \geq 1$$

$${x}_{j} \geq 0 and integer$$

where j is the daily shift pattern, xⱼ represents the decision variable for selecting alternative j, cⱼ represents the associated cost of selecting j, and aᵢⱼ is the variable that indicates whether or not the time period i is a scheduled work period in the daily shift pattern j.

When creating a schedule, it is important to consider the forecasted workload or demand as well as other objectives such as an individual employee's preferences. Other objectives that workforce scheduling needs to consider are certain regulations regarding minimum and maximum number of employee working hours during any given day or week, break rules and regulations, customer needs and forecasted demand, and individual employee skills, availability and scheduling preferences.

Generally, solving these types of workforce scheduling problems is considered to be NP-hard. That is, as the size of the problem grows, the complexity of the problem grows at least exponentially. Therefore, solving these types of workforce scheduling problems using classical operations research techniques typically takes several hours, which makes implementation with conventional workforce scheduling applications impractical.

An attractive option to classical operation research techniques are scheduling methodologies based on Artificial Intelligence (“AI”). AI generally refers to applications that are used to solve problems that normally require human intelligence. Typical problems solved by AI are speech recognition, pattern recognition, planning, and prediction. The most commonly used pattern recognition algorithm is the Artificial Neural Networks (“ANN”) algorithm. In general, ANN can be described as an AI approach that mimics the behavior of the human brain. An ANN is supervised to make decisions and answer questions in a similar fashion as a human being. Thus, with adequate training, an ANN is able to recognize certain patterns, for example, the input vector to the system x=(x₁, x₂, . . . , xₙ) returns the output vector y=(y₁, y₂, . . . , yₘ). A significant drawback of AI solutions is that it is difficult and time consuming to develop, train, and implement an AI solution. Consequently, AI solutions are cost prohibitive for conventional workforce scheduling applications.

Therefore, what is needed is a workforce scheduling system and method that overcomes these significant problems found in the conventional systems as described above.

### SUMMARY

The present invention creates an optimized workforce schedule for a set of local or remote human resources to insure optimum staff schedules based on forecasted demand, past schedules, employee skill sets, and employee preferences. Upon a request to create a schedule the system uses a pattern recognition procedure to create the initial workforce schedule. The pattern recognition procedure considers staff attributes and skills as well as past schedules to create the initial workforce schedule. The initial workforce schedule is then refined via a neighborhood search algorithm that incorporates user input, employee preferences, and historical scheduling patterns to generate an optimized schedule that meets the forecasted demand for selected positions while still satisfying employee preferences.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level block diagram illustrating an example network based system for dynamic scheduling of personnel according to an embodiment of the present invention;

FIG. 1A is a level block diagram illustrating an example network architecture for dynamic scheduling of personnel according to an embodiment of the present invention;

FIG. 2 is a flow diagram illustrating an example process for creating a workforce schedule according to an embodiment of the present invention;

FIG. 3 is a block diagram illustrating an example artificial neural network according to an embodiment of the present invention;

FIG. 4 is an example user interface displaying schedules for a set of staff members according to an embodiment of the present invention;

FIG. 5 is an example user interface for selecting the time period for which schedules are going to be created according to an embodiment of the present invention;

FIG. 6 is an example user interface for selecting the positions to be scheduled according to an embodiment of the present invention;

FIG. 7 is an example user interface for selecting how to schedule the workforce according to an embodiment of the present invention;

FIG. 8 is an example user interface for selecting the type of staff member to allow adjustment of shifts according to an embodiment of the present invention;

FIG. 9 is an example user interface for selecting the adjustment of forecasted demand for positions according to an embodiment of the present invention;

FIG. 10 is an example user interface for selecting how to select staff members to be scheduled according to an embodiment of the present invention;

FIG. 11 is a flow diagram illustrating an example process for creating an initial workforce schedule according to an embodiment of the present invention;

FIG. 12 is a flow diagram illustrating an example process for creating a refined workforce schedule according to an embodiment of the present invention; and

FIG. 13 is a block diagram illustrating an exemplary computer system as may be used in connection with various embodiments described herein.

### DETAILED DESCRIPTION

Certain embodiments as disclosed herein provide for an improved workforce scheduling system and method that provides for the automated creation of workforce schedules based on employee availability, preferences, skill sets, past performance, and staffing requirements such as forecasted demand for certain positions. For example, one method as disclosed herein employs pattern recognition based on past schedules and employee attributes to create an initial workforce schedule. The initial schedule is then refined to generate an optimized workforce schedule that includes considerations such as forecasted demand and employee preferences.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

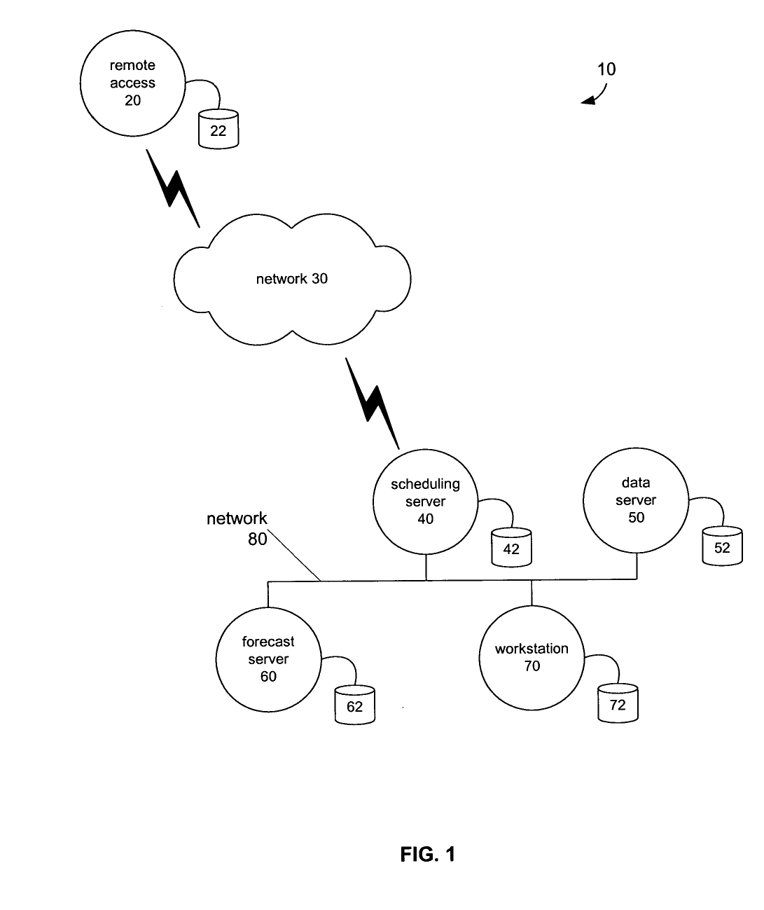

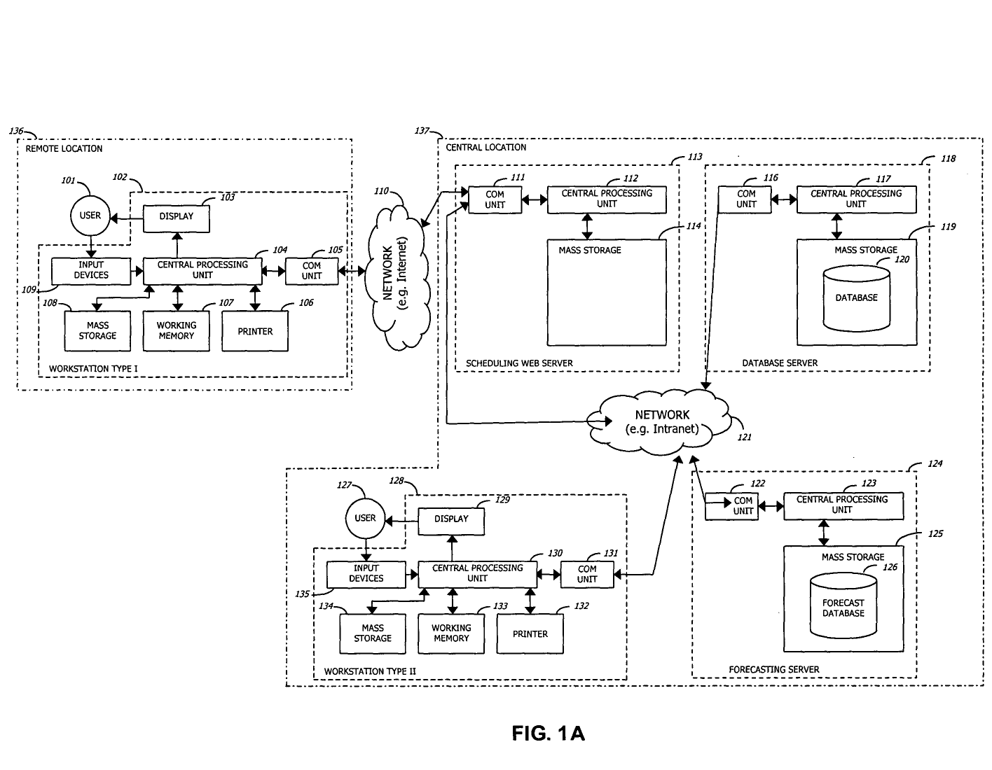

FIG. 1 is a high level block diagram illustrating an example network based system 10 for dynamic scheduling of personnel according to an embodiment of the present invention. In the illustrated embodiment, the system 10 comprises a remote access device 20 that is communicatively coupled with a scheduling server 40 over a data communications network 30. The scheduling server 40 is communicatively coupled with a data server 50, a forecast server 60, and one or more workstations 70 over a data communications network 80. In one embodiment, network 30 is the Internet and network 80 is a local corporate network. Alternatively, network 30 may be a leased line or a dial up connection over, for example, a telecommunications network.

The remote access device 20 is additionally configured with a data storage area 22, the scheduling server 40 is configured with a data storage area 42, the data server 50 is configured with a data storage area 52, the forecast server 60 is configured with a data storage area 62, and the workstation 70 is configured with a data storage area 72.

Alternative network and geographic distributions of the various devices, servers, workstations, and data storage areas may also be employed. Similarly, the various devices, servers, and workstations may be implemented separately as shown or they may be integrated into multifunctional devices. For example, the scheduling server 40, data server 50, and forecast server 60 may be combined into a single device. Also, the data storage areas 40, 50, and 60 may be combined, whether their corresponding servers are separate or also combined.

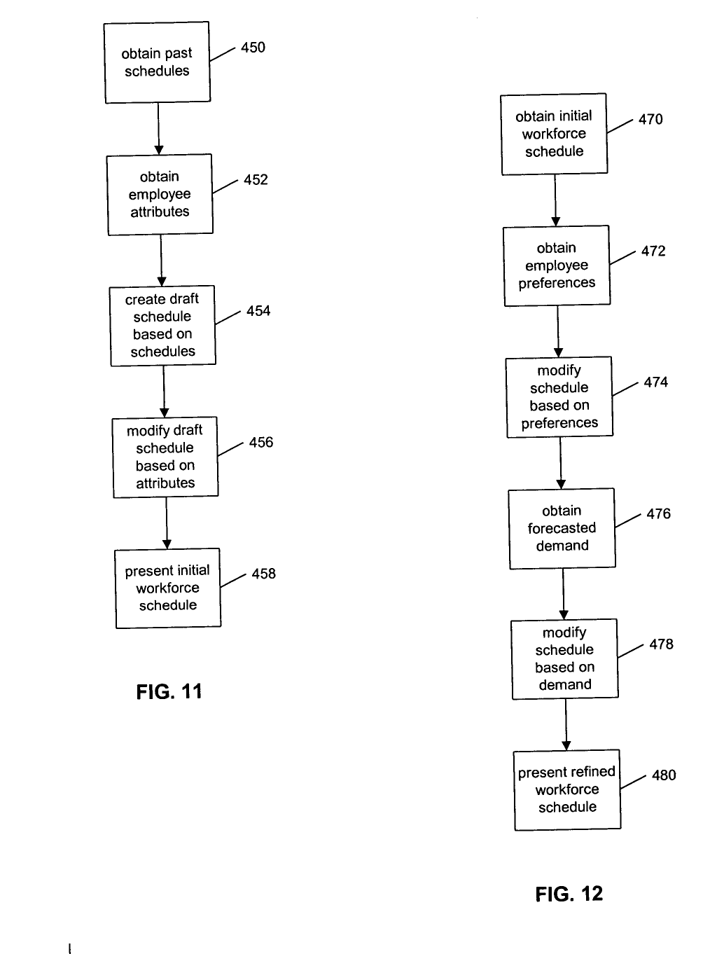

The remote access device 20, the various servers 40, 50, and 60, and the one or more workstations 70 are all preferably computer enabled devices such as that generally described with respect to FIG. 11. While their general computational characteristics may be similar, these devices, servers, and workstations may employ a wide variety of hardware and software components to perform their specific function. Such hardware and software components (e.g., the operating system, network connectivity (wired or wireless), and storage capabilities (persistent and volatile)) are well known in the art and will therefore not be described in detail.

The remote access device 20 preferably allows a local operator to interact with the scheduling server to create an optimized schedule for the relevant workforce. For example, the remote access device 20 may be located at a factory or warehouse that is part of a large organization. Preferably, the remote access device allows a local operator to interact with the organization's workforce scheduling system even though the local warehouse may be physically isolated from the organization's main office by geographical or political boundaries.

FIG. 1A is a block diagram illustrating an example of a network architecture for dynamic scheduling of personnel according to an embodiment of the present invention. In the illustrated embodiment, the overall architectural data flow and interrelationships between a remote access point location and the central server location in the system are shown. Before the remote user 101 located at the remote location 136 can schedule their employees, a forecast of customer demand needs to be created for each customer initiated activity. The forecast is generated by the central user 127 at the central location 137. The central user 127 uses the database 120 to create a new forecast of customer demand at the remote location. Alternatively, the remote user 101 could perform this function. The new forecast is created using data stored in the database 120 on the database server 118. The new forecast is stored in the forecasting database 126 located on the forecasting server 124. After the central user 127 has created a new forecast this forecast is pushed to the database 120 stored on the database server 118. After the central user 127 has input the necessary forecasts, the number of resources required can be estimated for each time period, for example by using queue theory formulas. The remote user 101 can now create schedules for their workforce.

When the remote user 101 logs into the scheduling web server 113 a scheduling application 403 as well as forecasted workloads and past schedules are accessed over the network 110 from the scheduling web servers 113 and the appropriate resource and remote location information is downloaded from the schedule database 120 to the working memory 107. Alternatively, this data may remain stored in the central location while the user interface displays the relevant information at the remote location 136. The remote user 101 views the schedules using a display 103 or perhaps by using a printer 106 to print a copy a schedule. The remote user 101 can use an input device 109 such as a keyboard or a mouse to create or alter schedules or provide other input that allows for the creation or modification of an optimized schedule. While making changes to a schedule the temporary schedule is saved on the mass storage 108 or alternatively in working memory 107. Alternatively, the temporary schedule could be saved on mass storage 114 or a volatile memory that is available to the scheduling server 113. Upon saving and exiting the application at the remote location 136, the optimized schedule is pushed over the network 110 from the remote location 136 to the central location 137 where it is saved in the database 120.

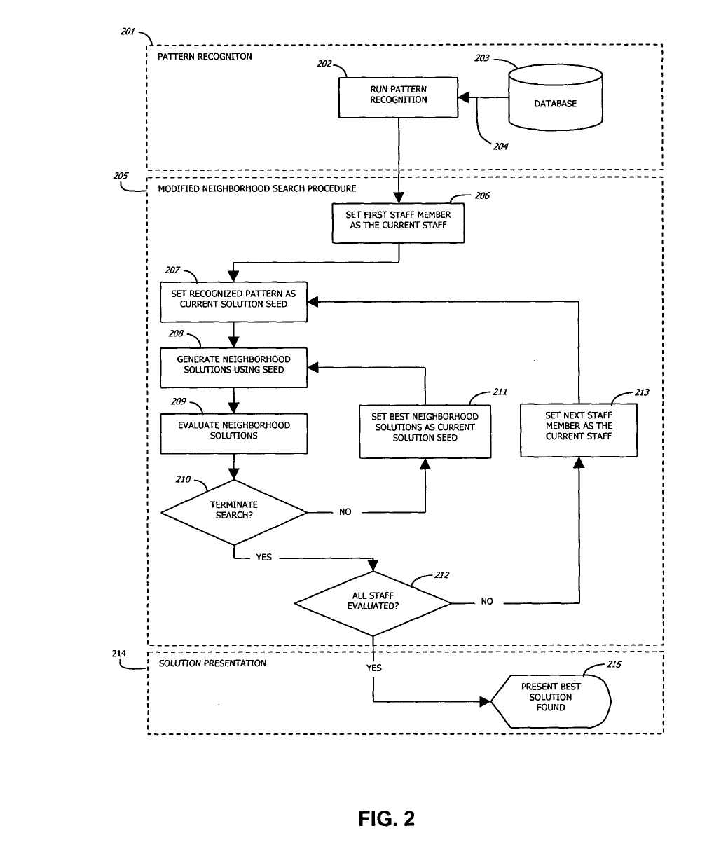

FIG. 2 is a schematic architecture of a feed forward Artificial Neural Network (“ANN”) 301. In the illustrated embodiment, ANN 301 consists of three layers, input layer 303, hidden layers 304, and output layer 305. Within each layer there are multiple neurons 308 located. These neurons 308 are connected 307 with each other, where each connection has a certain weight dependent on its importance when recognizing the scheduled patterns. By setting the input parameters 302 to the ANN 301 the proposed schedule is calculated as the output 306 from the ANN 301.

Upon launching the application for creating schedules the skills and preferences of employees as well as past schedules are gathered from database 203 located on the central web server 113. In one embodiment, ANN 301 is trained to recognize resource dependent and time dependent shift patterns, where resource dependent patterns could be that a resource is working a particular position every day, whereas a time dependent pattern could be that a specific task needs to be performed during a specific time period. Furthermore, the ANN 301 is also trained to recognize ratio dependent patterns. For example, for each position of type I at least four units of position of type II are required.

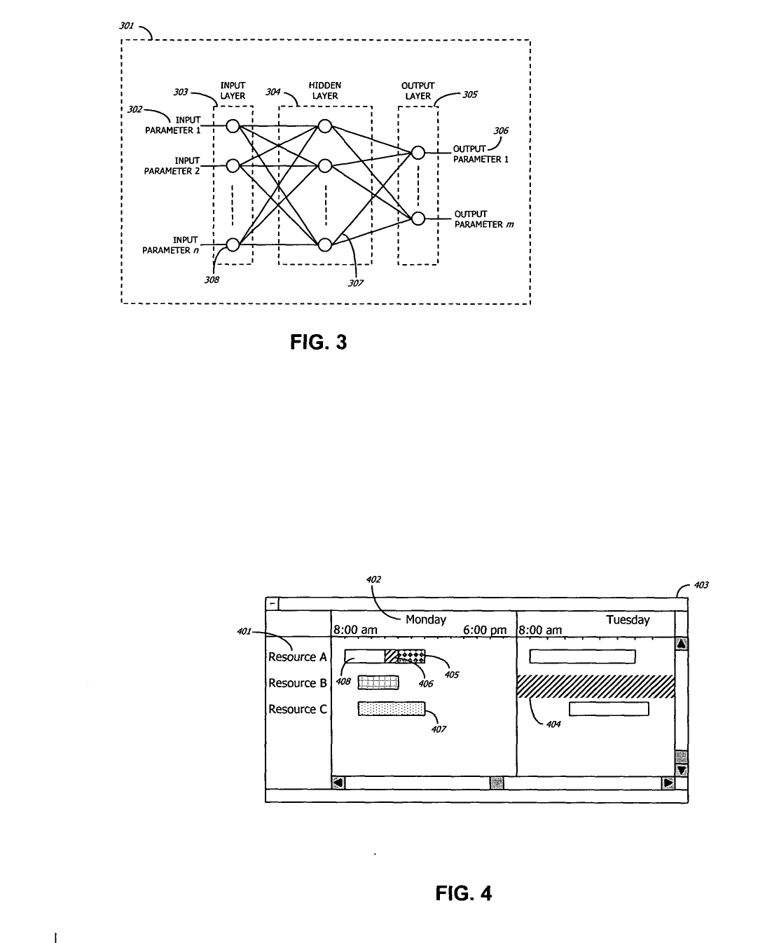

FIG. 3 is a schematic drawing of the overall data flow of the scheduling process. Within the data flow FIG. 3 the ANN 301 is used to recognize the initial schedules 202 for the workforce. This is done by setting the input nodes 308 in the input layer 304 to the values of past schedules. Upon creation of the initial workforce schedule, a modified neighborhood search methodology 205 is used for optimization of the workforce schedule. The neighborhood search 205 is an iterative search procedure that starts with an initial seed 207. In one embodiment, the initial seed is the initial workforce schedule generated by the pattern recognition.

Using the initial seed, alternative schedules are created. The alternative schedules are also referred to as neighborhood solutions. For example, while the initial workforce schedule may indicate that an employee is working from 8:30-11:00 am, an alternative, or neighborhood schedule might indicate that the employee is working from 8:00-10:30 am. A plurality of neighborhood solutions are generated and evaluated in step 209. If no improvement was found among the alternative solutions the search for the current staff member is terminated 210 and the search continues with the next staff member 213. If a better solution is found among the alternative solutions for a staff member, then the improved solution is used as the seed for the next iteration 221. This procedure continues until all staff members have been evaluated 212. After termination 212 the optimized workforce schedule is presented to the user 101 using the scheduling interface 403. The optimized workforce schedule is also saved on the local computer 102 before being pushed over the network 110 back to the database server 118.

FIG. 4 is an example user interface 403 displaying schedules for a set of staff members according to an embodiment of the present invention. The interface 403 shows a plurality of schedules 405-408 for the various staff members 401 at a single location or multiple locations. Each staff member 401 can be scheduled for multiple positions 405-408 on a single day. Using templates, an operator can specify when individual staff members are available to work and when individual staff members have requested time off. For example, schedule 404 shows requested time off. When the ANN 301 recognizes patterns in past schedules, such patterns are considered when creating the initial workforce schedule.

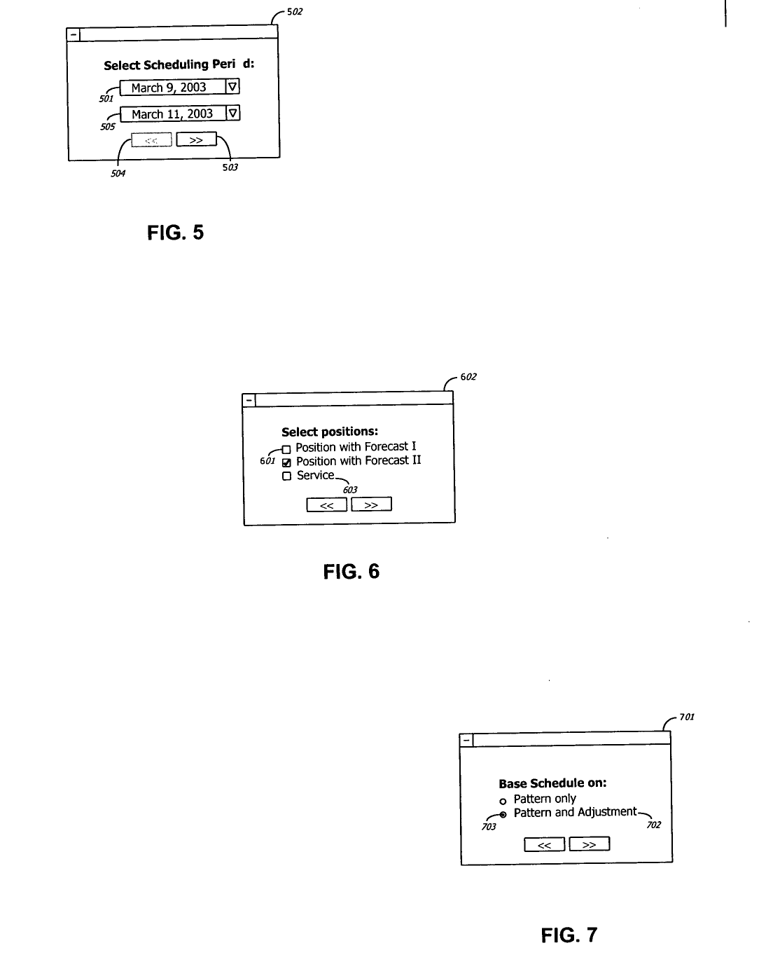

FIG. 5 is an example user interface 502 for selecting the time period for which schedules are going to be created according to an embodiment of the present invention. The scheduling period can be a single day or multiple days. In the illustrated embodiment, an operator selects the start date 501 and the end date 505 of the scheduling period. This information, along with other information, is later provided to the ANN so that the initial workforce schedule can be created.

FIG. 6 is an example user interface 602 for selecting the positions to be scheduled according to an embodiment of the present invention. The operator/user can select a single position or multiple positions using checkboxes 601. Advantageously, the various options for single or multiple positions may also provide for a plurality of forecasted demands. For example, a first option may have a forecasted demand that can be satisfied by a single employee while a second option may have a forecasted demand that requires multiple employees.

FIG. 7 is an example user interface 701 for selecting how to schedule the workforce according to an embodiment of the present invention. In the illustrated embodiment, the operator may create schedules based solely on recognized patterns or based on recognized patterns in combination with a heuristic adjustment procedure that can be employed to better predict and meet forecasted demand. An operator/user can make this selection by choosing the appropriate option 703 from the list of available options 702 as shown.

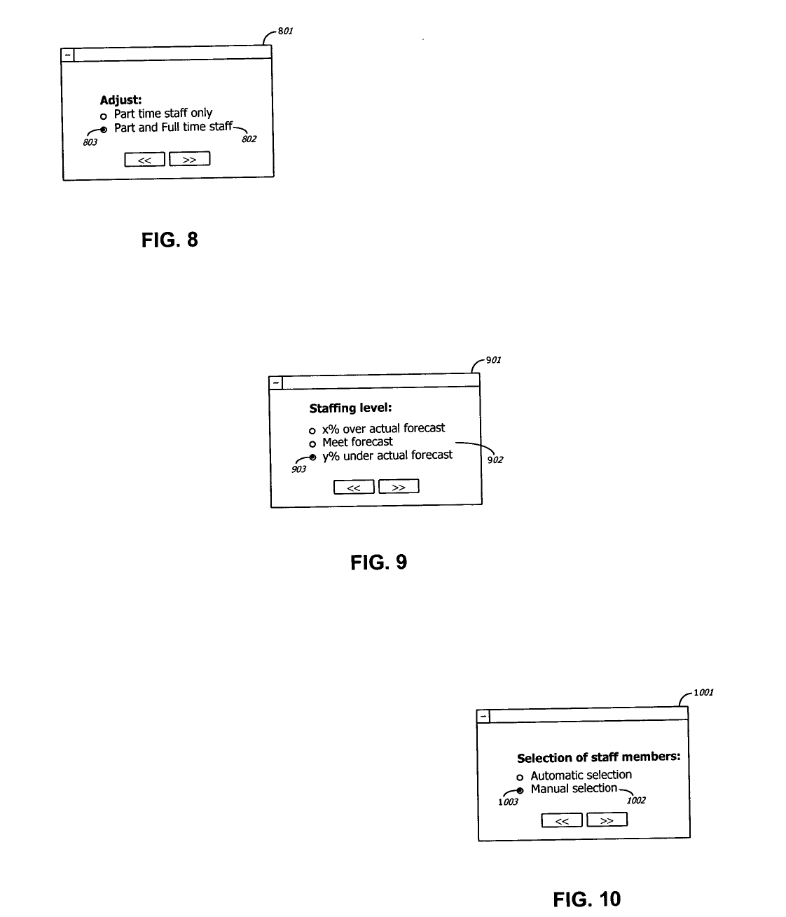

FIG. 8 is an example user interface 801 for selecting the type of staff member to allow modification of shifts according to an embodiment of the present invention. An operator/user can make the selection by choosing the appropriate option 803 from the list of available options 802 as shown. For example, in the illustrated embodiment, the operator may select between allowing adjustments for part time staff only or for part time staff as well as full time staff.

FIG. 9 is an example user interface 901 for selecting the adjustment of forecasted demand for positions according to an embodiment of the present invention. Since the forecasted demand is based on historical data, an operator/user has the option of adjusting the staffing level to be over, under, or congruent with the forecasted demand. For example, a change in the interest rate for mortgage loans may increase the forcasted demand for a particular day or week; the financial institution may be located close to a university and therefore have reduced demand during breaks in the class schedule, etc. An operator/user can make the selection by choosing the appropriate option 903 from the list of available options 902 as shown.

FIG. 10 is an example user interface 1001 for selecting how to choose staff members to be scheduled according to an embodiment of the present invention. In certain instances, when the forecasted demand hits a peak, the normal daily staff level (historical level) may not be sufficient and additional staff required. Alternatively, when the forecasted demand is sufficiently low, a reduction in staff may be required. In the illustrated embodiment, the user interface 1001 allows an operator/user to make the selection by choosing the appropriate option 1003 from the list of available options 1002 as shown.

FIG. 11 is a flow diagram illustrating an example process for creating an initial workforce schedule according to an embodiment of the present invention. The steps in this process may be performed in the order that is shown or they may be performed in a different order. Initially, in step 450, the past workforce schedules are obtained. Advantageously, the past schedules provide information relevant to the particular needs for the corresponding new schedule to be created. For example, a particular industry such as the service industry may have very cyclical needs for staffing according to the day of the week, day of the month, or day of the year.

Next, in step 452, the employee attributes are obtained. The employee attributes may include a variety of information about individual employees, for example, language skills, product knowledge, and ability to operate machinery, just to name a few. Other attributes preferably provide information related to the skill sets of individual employees with respect to performing job related tasks and also with respect to interpersonal skills, customer relation skills, and managerial skills.

Once the employee attributes and past schedules have been obtained, in step 454 a draft schedule is created. The draft schedule can preferably track previous schedules for the particular day of the week, day of the month, and day of the year. For example, the schedule may be for a non-holiday Tuesday during the conventional school year so it can preferably track previous schedules for non-holiday Tuesday's during the conventional school year.

After the draft schedule has been created, in step 456 the draft schedule is modified based on the employee attributes. For example, one employee on each shift may be required to know first aid, or be capable of operating a particular machine. Alternatively, each shift may require that one employee be designated as an assistant manager or some other level of seniority. Thus, the draft schedule is revised in order to make sure that the required employee attributes are met for each shift. In one embodiment, the required attributes may be predefined. Alternatively, the required attributes may be entirely entered by an operator, or supplemented by operator entry. Once the draft schedule has been modified, then the initial workforce schedule can be presented, as illustrated in step 458.

FIG. 12 is a flow diagram illustrating an example process for creating a refined workforce schedule according to an embodiment of the present invention. The steps in this process may be performed in the order that is shown or they may be performed in a different order. Initially, in step 470, the initial workforce schedule is obtained. The initial workforce schedule can preferably be obtained from volatile memory, persistent memory, or a removable media storage device. Once the initial workforce schedule has been obtained, in step 472 the employee preferences are also obtained. Employee preferences can be obtained from persistent memory or they may alternatively be entered by an operator.

Upon obtaining the employee preferences and the initial workforce schedule, the schedule is modified in step 474 based on the employee preferences. Employee preference may include such information as requested time off, requests to not be scheduled with other particular employees or managers, requests to be scheduled with other particular employees or managers, requests for certain assignments, and the like.

Next, as shown in step 476, the forecasted demand for the particular schedule is obtained. This information may be entered by an operator or it may be fetched from volatile or persistent memory. Additionally, the forecasted demand may be calculated from historical data and refined with predictive data entered by an operator either recently or in real time.

After the forecasted demand is obtained, in step 478 the schedule is modified based on the forecasted demand. Modification of the schedule based on the demand may include reducing the number of employees scheduled, increasing the number of employees scheduled, or modifying the scheduled employees to include more experienced employees capable of handling increased demand or modifying the scheduled employees to include less experienced employees (i.e., employees with reduced pay requirements) that are capable of more efficiently handling the forecasted demand at an appropriate level of service. Once the schedule has been modified, the refined workforce schedule is presented, as illustrated in step 480.

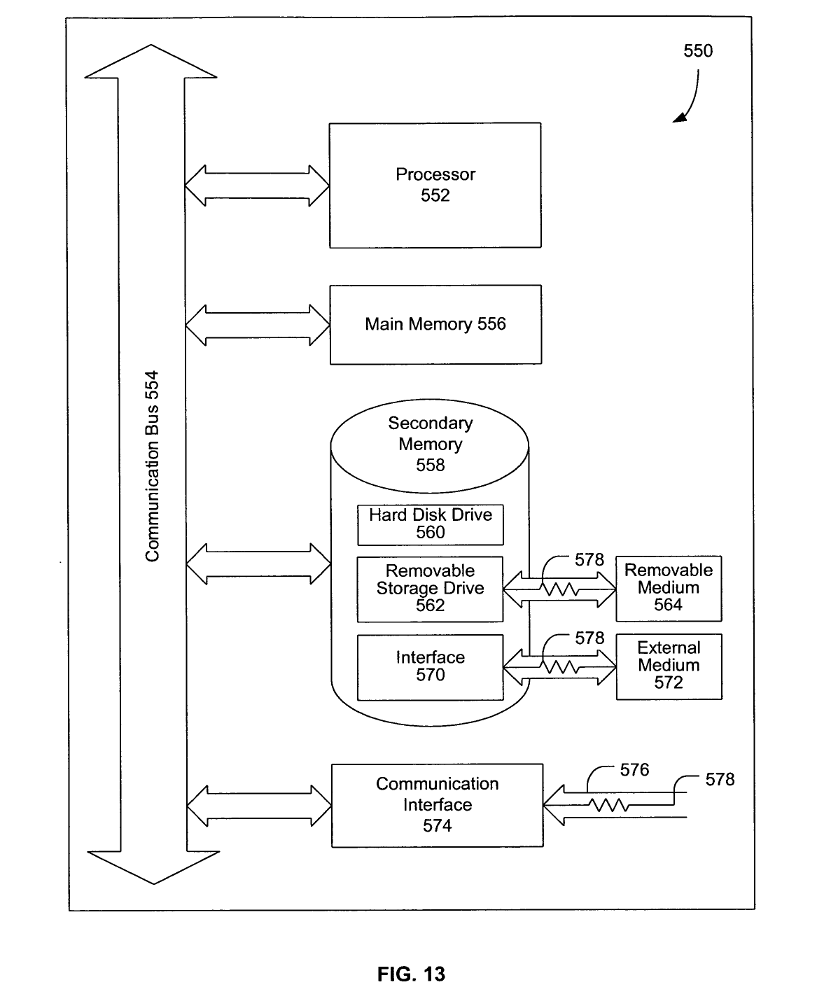

FIG. 13 is a block diagram illustrating an exemplary computer system 550 that may be used in connection with the various embodiments described herein. For example, the computer system 550 may be used in conjunction with [describe various uses for a general purpose computer in relation to the invention]. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of communication means including wire or cable, fiber optics, conventional phone line, cellular phone link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

While the particular system and method for dynamic scheduling of personnel herein shown and described in detail is fully capable of attaining the above described objects of this invention, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A computer implemented method for automatically generating an optimized workforce schedule, comprising:
creating an initial workforce schedule based on past schedules and employee attributes; and
refining the initial workforce schedule to generate an optimized workforce schedule based on the initial workforce schedule, forecasted demand, and employee preferences.

2. The method of claim 1, wherein creating an initial workforce schedule further comprises using a pattern recognition procedure to recognize past resource shift patterns for a particular employee position.

3. The method of claim 1, wherein employee attributes comprise an employee's skill set.

4. The method of claim 1, wherein employee preferences comprise an employee's desired number of hours.

5. The method of claim 1, wherein the refining step further comprises receiving a forecasted demand as input.

6. The method of claim 5, wherein the forecasted demand is for a single employee position.

7. The method of claim 5, wherein the forecasted demand is for multiple employee positions.

8. The method of claim 1, wherein the refining step further comprises generating an optimized workforce schedule based on resource availability.

9. The method of claim 1, wherein the refining step further comprises generating an optimized workforce schedule based on a predefined number of work hours per week for an employee.

10. The method of claim 1, wherein the refining step further comprises generating an optimized workforce schedule based on full time and part time employee availability.

11. The method of claim 1, further comprising receiving a modification to the optimized workforce schedule from a user.

12. The method of claim 11, wherein the modification is received via an input device configured to provide changes for a particular resource through a user interface.

13. The method of claim 12, wherein the input device is a mouse.

14. The method of claim 12, wherein the input device is a keyboard.

15. The method of claim 1, wherein the forecasted demand comprises multiple forecasts for a particular position.

16. The method of claim 1, wherein the resources selected for the initial workforce schedule are predefined.

17. The method of claim 1, wherein the resources selected for the initial workforce schedule are dynamically selected.

18. The method of claim 1, wherein the refining step further comprises:
creating an alternative schedule;
comparing the alternative schedule to the initial schedule to determine the optimal schedule; and
using the optimal schedule as the optimized workforce schedule.

19. The method of claim 1, wherein employee resources are located in a centralized pool of resources.

20. The method of claim 1, further comprising generating a color coded report to illustrate how closely the optimized workforce schedule is meeting the forecasted demand for a given position.

21. A system for automatically generating an optimized workforce schedule, comprising:
a scheduling server;
an access device communicatively coupled with the scheduling server over a data communications network, the access device configured to allow a user to interact with the scheduling server;
a data storage area configured to store past schedules, forecasted demand, and employee attributes;
wherein the scheduling server creates an initial workforce schedule based on said past schedules, forecasted demand, and employee attributes; and
wherein the scheduling server creates an optimized workforce schedule based on user input via the access device.

22. The system of claim 21, wherein the access device and the scheduling server are at different locations.

23. The system of claim 21, wherein the scheduling server uses pattern recognition to recognize past resource shift patterns for a particular employee position.

24. The system of claim 23, wherein the scheduling server uses the past resource shift patterns to create the initial workforce schedule.

25. The system of claim 21, wherein the access device allows a user to adjust the forecasted demand for an employee position.

26. The system of claim 21, wherein the scheduling server is further configured to consider resources availability when creating the initial workforce schedule.

27. The system of claim 21, wherein the scheduling server is further configured to consider a predefined number of work hours per week for an employee when creating the optimized workforce schedule.

28. The system of claim 21, wherein the scheduling server is further configured to consider an employee skill set when creating the optimized workforce schedule.

29. The system of claim 21, wherein the scheduling server is further configured to consider full time and part time employee availability when creating the optimized workforce schedule.

30. The system of claim 21, wherein the access station comprises a mouse input device that allows a user to modify an optimized workforce schedule.

31. The system of claim 21, wherein the access station comprises a keyboard input device that allows a user to modify an optimized workforce schedule.

32. The system of claim 21, where in the forecasted demand comprises multiple forecasts for a particular position.

33. The system of claim 21, further comprising a report generator configured to provide a color coded report identifying how close the optimized workforce schedule is meeting the forecasted demand for a given position.

34. The system of claim 21, wherein the data storage area is coupled with a data server that is separate from the scheduling server.
